(19) United States
(12) Patent Application Publication
(10) Pub. No.: US 2006/0169638 A1
(43) Pub. Date: Aug. 3, 2006

(54) Chromatography method for ion detection and analysis

(76) Inventors: Yury Zelechonok, Northbrook, IL (US); Vladislav Orlovsky, Wheeling, IL (US)

Correspondence Address: Charles F. Lind, 120 W. Eastman, #300, Arlington Hts., IL, 60004, US

(21) Appl. No.: 11/045,191

(22) Filed: Jan. 31, 2005

(51) Int. Cl. B01D 15/08

(52) U.S. Cl. 210/635; 210/656; 210/660

(57) ABSTRACT

This ion chromatography method utilizes a HPLC column having a stationary phase with two functional groups permanently attached thereto, respectively for ion-exchange and for hydrophobic interaction. The mobile phase will have an organic modifier, and an ionic modifier and will carry sample ions. The mobile phase organic modifier can be conventional HPLC organic solvent, while the mobile phase ionic modifier can be a weak hydrophobic base (for cation-exchange) or a weak hydrophobic acid (for anion-exchange). The stationary phase ion-exchange group can be a base or acid residue and the hydrophobic functional group can be an alkyl chain. The hydrophobic group of ionic modifier has a strong non-ionic interaction with the hydrophobic group of the stationary phase, which facilitates the ion-exchange process and the ion separation as the result.

### BACKGROUND OF THE INVENTION

Ion chromatography (IC) is commonly used to detect and quantify different ions in a sample. High performance liquid chromatography (HPLC) is used to identify and quantify individual materials, components, etc. contained in a sample. The IC and HPLC instruments are related, but are quite different.

To clarify, a typical IC instrument is schematically illustrated in FIG. 1a, including solvent vessels connected by capillary lines for solvent flow through a degasser, a high pressure reciprocating pump, an autosampler, an ion-exchange separation column, an ion suppresser, a conductivity detector, and waste lines.

The HPLC instrument generally has the same components and flow scheme, except the IC instrument almost exclusively uses a conductivity detector. In both types of instruments, the solvent(s) as a mobile phase is forced by the pump under high pressures at a substantially uniform flow rate through the column. Periodically, a small quantity of the liquid sample is injected by the autosampler into this mobile phase stream to flow somewhat as an isolated slug until reaching the column. The column causes different rates of elution of the different components in the sample, so they exit the column individually. The detector can typically detect and identify the isolated components based on their retention time.

Most IC instruments use purified water as a primary solvent and an acid or base added thereto for making the mobile phase capable to provide ion-exchange process on a column. As result the mobile phase became excessively conductive. The conductivity suppressor strips ions from the mobile phase, leaving the pure water and sample ions for downstream detection.

In addition to the existing IC instrument requiring the use of the ion suppressor, several additional drawbacks exist.

Every element of the IC instrument should be compatible with or resistant to the mobile phase components, which can frequently include strong acidic or basic solutions needed for ion separation. Stainless steel (commonly used in HPLC instruments) is not compatible with strong acid (such as HCl). This requires existing IC instruments to be different from HPLC instruments, typically needing more expensive structural materials to define the solvent flow path. Thus, even though HPLC instruments are less expensive and more commonly used than IC instruments, they cannot typically function as an IC instrument.

Some applications require higher sensitivity than the typical IC instruments can offer. Sensitivity might be increased by using an analyte pre-concentrator, although this procedure is more complex and expensive and is not preferred. Also, should an IC instrument not be compatible with some high content organic samples, it might be necessary to clean the samples or to convert them to a water soluble form before being analyzed for ions.

To summarize, the IC instrument major problems now are: the need for using an ion-suppressor; the need for special materials for defining a corrosive solvent flow path; the limitations of instrument sensitivity because of the residual water conductivity; and the inability to use concentrated organic mobile phases.

After reviewing the following invention, one might speculate that using some of the same teachings on existing IC systems would be possible. For example, could a low ionization constant acidic compound, such as a weak carboxylic acid, be used as a mobile phase additive to the water solvent, to reduce the background mobile phase conductivity and excessive corrosive of stainless steel instruments? Also, could a high organic concentration mobile phase be used to expand the range of samples that could be introduced to the instrument? However, it is believed that the needed ion equilibrium or flow through chromatography action would be impaired and discontinued, so that such efforts would likely be unsuccessful.

### OBJECTS AND SUMMARY OF THE INVENTION

An object of this invention is to provide an efficient and reliable method of using a HPLC instrument as an IC instrument, for detecting even trace amounts of ions with detection limit superior to typical ion-chromatography instrument.

A more detailed object and summary of this invention is to provide a method of using a conventional HPLC instrument having a conductivity detector for IC operation, the instrument having a flow through column filled with stationary phase absorbent modified with two different functional groups attached to the surfaces thereof operable respectively for ion-exchange and hydrophobic interaction with the mobile phase of organic/water and a weak acid or base modifier, operable to have sequential exiting from the column of the different sample ions for detection and analysis in the instrument detector, and without needing either special structural materials for the instrument mobile phase flow path or a conductivity suppressor.

Another more detailed object and summary of this invention is to provide the above method with a mobile phase of water and any conventional HPLC organic modifier and with the stationary phase having a hydrophobic functional group as an alkyl chain and with an ion-exchange functional group as a negatively charged acid for cation-exchange and as a positively charged base for anion-exchange.

### BRIEF DESCRIPTION OF THE DRAWINGS

The accompanying drawings illustrate specific embodiments of the invention, which with the following specification disclose the principles of the invention, wherein:

FIGS. 1a and 1b show comparative schematics of prior art IC and HPLC instruments, this invention being like FIG. 1b;

FIGS. 2a and 2b are representative plots of the conductivity of water/methanol and water/acetonitrile mixtures;

FIGS. 3a and 3b show schematics of chemical structures of the stationary column phases used in the present invention;

FIGS. 4a, 4b, 4c and 4d show comparative equilibrium equations of traditional IC and the inventive methods; and

FIG. 5 shows a chromatogram and analysis condition that can be obtained with the inventive apparatus and method.

### DETAILED DESCRIPTION OF THE INVENTION

The inventive IC instrument and method utilize unique combination of column stationary phase and of the mobile phase to be passed through the column.

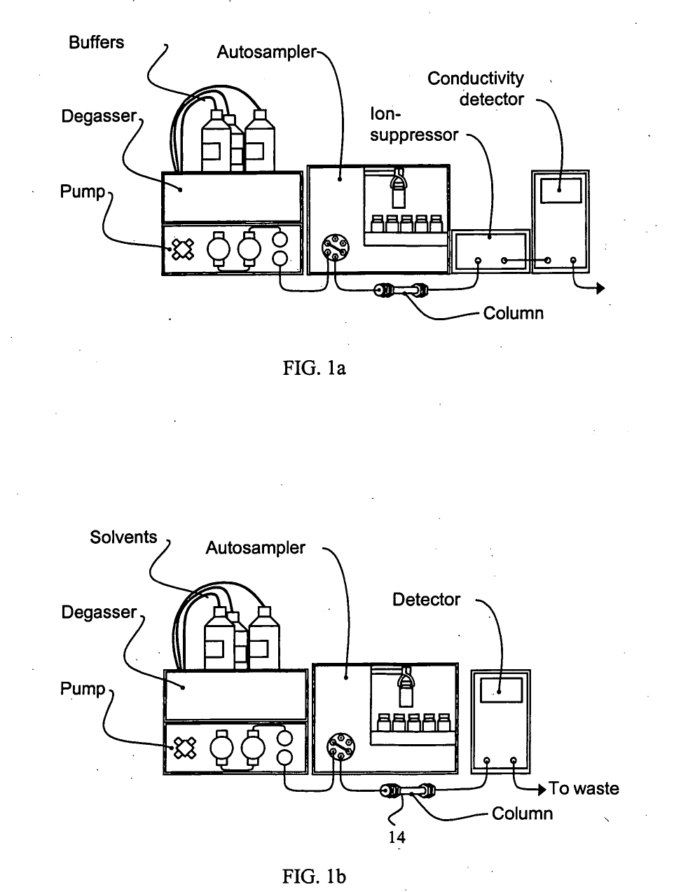

The column stationary phase 10a, 10b (schematically illustrated in FIGS. 3a, 3b respectively) will be defined by porous or non porous granular particles 12a, 12b being packed into the hollow flow through region of the column 14 (FIG. 1b). The particles will have high surface areas, which would be modified to have two functional groups 16a, 18a (FIG. 3a) and 16b, 18b (FIG. 3b) chemically or otherwise permanently attached thereto. The stationary phase group (16a and 16b) will be for ion-exchange interaction and the stationary phase group (18a and 18b) will be for providing hydrophobic interaction with the mobile phase flowing through the column.

More specifically, FIG. 3a illustrates ion-exchange stationary phase structures 16a suited for anion-exchange chromatography, while FIG. 3b illustrates ion-exchange stationary phase structures 16b suited for cation-exchange chromatography. The ion-exchange-group 16a, 16b might be acidic or basic, such as a carboxylic acid (acidic) or an amino (basic). The hydrophobic stationary phase group 18a, 18b might be a long alkyl chain.

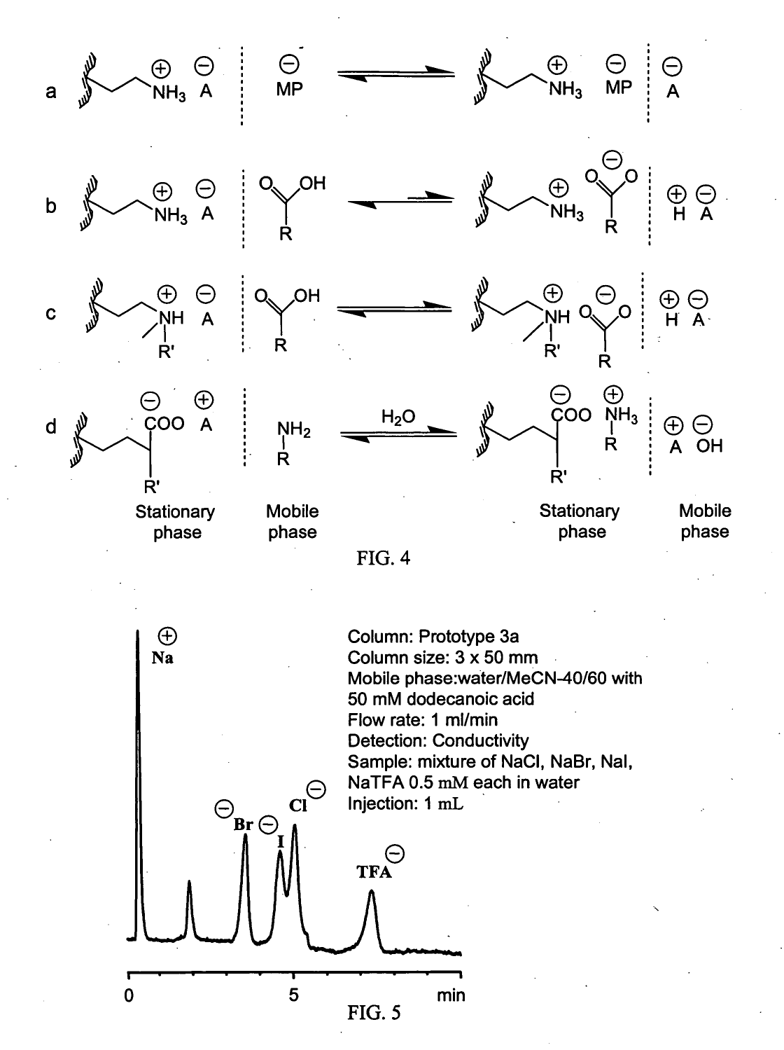

The mobile phase to be passed through the stationary phase will be comprised of a water/organic mixture with a weak acid additive for anion-exchange or with a weak base additive for cation-exchange with the concentration of acidic or basic additives in amounts possibly from 1 to 5000 mM. Weak acid and weak base should be of hydrophobic nature. Either mobile phase will interact with the two functional groups of the stationary phase to yield ion-exchange equilibrium as illustrated in FIG. 4c and 4d.

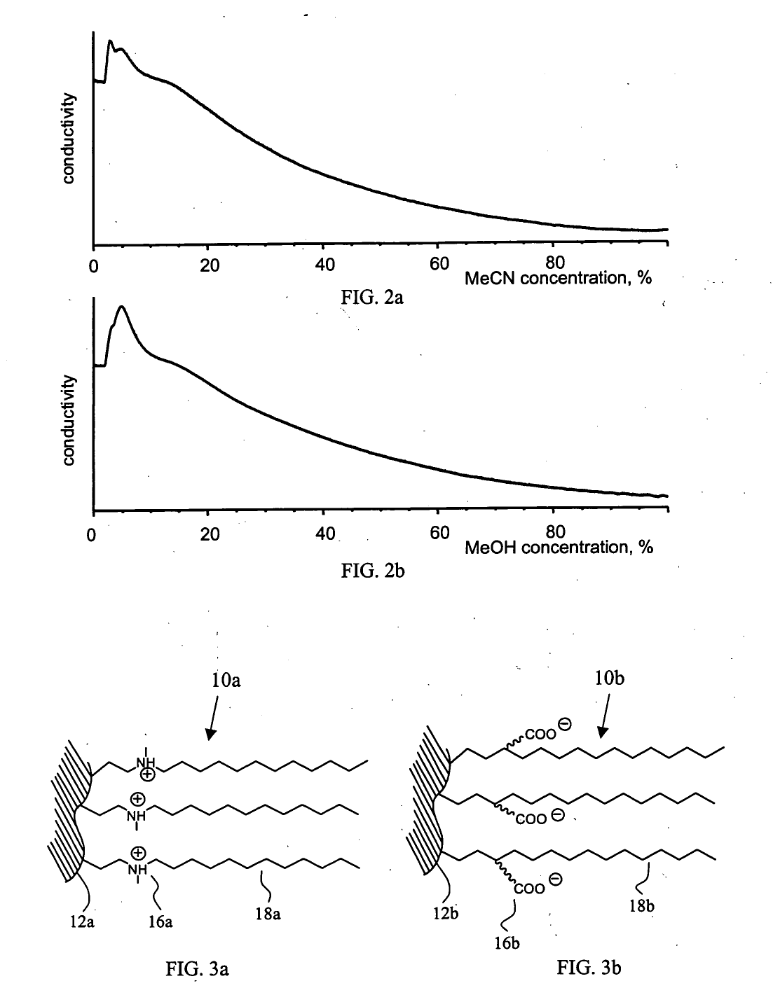

The high organic concentration in the mobile phase lowers the conductivity of the mobile phase, as higher organic concentrations of common HPLC organic solvents in water provides for lower conductivity than pure water alone. Typical conductivity curves involving organic concentrations in water are illustrated in FIGS. 2a and 2b for the organic solvents of methanol (MeOH) and acetonitrile (MeCN). Other alcohols (EtOH etc), tetrahydrofuran (THF), dimethylsulfoxide (DMSO), etc. could also be used as the mobile phase modifier.

FIG. 4c illustrates schematically two equilibrium states of the anion-exchange stationary phase. The first state has the analyte (A−) bounded to the stationary phase. The second state has the analyte replaced by anionic modifier (RCOOH) of the mobile phase. The R group of ionic modifier has a strong non-ionic interaction with the RI group of the stationary phase. This interaction facilitates the ion-exchange process, which ends up with the charge transfer from the stationary phase ionic group to the ionic modifier weak acidic group (COOH). Similarly FIG. 4d illustrates schematically two equilibrium states of the cation-exchange stationary phase. The first state has the analyte (A+) bounded to the stationary phase. The second state has the analyte replaced by cationic modifier (RNH₂) of the mobile phase. The R group of the cationic modifier has a strong non-ionic interaction with the R′ group of the stationary phase. This interaction facilitates the ion-exchange process, which ends up with the charge transfer from the ionic modifier basic group (NH₂) to the stationary phase ionic group.

This repeated equilibrium produce chromatography separation and allows the differential migration of the different sample ions through the column.

This invention utilizes the concept that if both a weak acidic or weak basic ionic modifier of the mobile phase and the stationary phase have strong hydrophobic properties, then the equilibrium will be shifted sufficiently toward a bound state where acidic group and basic group are ionized as illustrated in FIG. 4c and 4d and ion-exchange will take place.

In this case, the mobile phase will have little conductivity of its own especially when high concentration of organic modifier in the mobile phase is used so that enhanced sensitivity of detection will be possible.

By contrast, the equilibrium stage of a traditional IC ion-exchange method is illustrated schematically in FIG. 4a, which requires significant concentration of ions in the mobile phase to participate in the ion-exchange process. The high mobile phase ion concentration increases the mobile phase conductivity (produce high background signal and noise respectively), making the use of an ion-suppressor a requirement.

Direct use of a weak acidic compound as proposed with this invention does not work with the stationary phase of a typical IC column, due to weak interaction of the mobile phase (as illustrated in equation 4b), as the free non-ionized acid does not produce efficient ion-exchange process. Without efficient ion-exchange process the analyte can become irreversibly attached to the stationary phase and not timely be exited from the column.

The method of the present invention reduces cost of ion analysis since the mobile phase itself has very low conductivity so that an ion suppression device need not be used. Also, as the solvents are not highly corrosive, no special structural materials must be used to form the mobile phase flow path, so that the method can be used with most conventional HPLC instruments having a conductivity detector. Also, the inventive method increases the sensitivity of ion detection due to fewer mobile phase ions and lower mobile phase conductivity with the allowed high organic concentration therein.

While this disclosure teaches only specific examples of the invention, the disclosure is not intended in a limiting sense. The claimed invention can be practiced using other equivalent variations not specifically described while obtaining useful beneficial results. Accordingly, the scope of the invention is to be appreciated and limited by the following claims.

What is claimed as our invention is:

1. A method of ion chromatography, comprising:
providing a mobile phase consisting of water, an organic modifier, and an ionic modifier;
providing a flow through column having a stationary phase formed with two functional groups permanently fixed therein,
the first functional group being for ion-exchange, either acidic for cation separation or basic for anion separation,
the second functional group being for hydrophobic interaction; and
passing the mobile phase through the column to detect ions exited from the column with a conductivity detector.

2. A method of ion chromatography according to claim 1, further comprising the mobile phase organic modifier being of any of the solvents methanol (MeOH), other alcohols (EtOH, IPA etc), acetonitrile (MeCN), Tetrahydrofuran (THF), or dimethylsulfoxide (DMSO) and some other.

3. A method of ion chromatography according to claim 1, further comprising the mobile phase ionic modifier being a weak hydrophobic base for cation-exchange chromatography, or weak hydrophobic acid for anion-exchange chromatography, each having an alkyl chain.

4. A method of ion chromatography according to claim 1, further comprising the stationary phase ion-exchange functional group being a carboxylic acid or an amine base.

5. A method of ion chromatography according to claim 1, further comprising the column stationary phase hydrophobic interaction functional group being an alkyl chain.

6. A method of ion chromatography according to claim 1, further comprising the mobile phase organic modifier being of any of the solvents methanol (MeOH), other alcohols (EtOH, IPA etc), acetonitrile (MeCN), tetrahydrofuran (THF), or dimethylsulfoxide (DMSO), and the mobile phase ionic modifier being a weak hydrophobic base for cation-exchange chromatography, or acid for anion-exchange chromatography, each having an alkyl chain.

7. A method of ion chromatography according to claim 1, further comprising the stationary phase ion-exchange functional group being a carboxylic acid or an amine base, and the column stationary phase hydrophobic interaction functional group being an alkyl chain.

8. A method of ion chromatography according to claim 1, further comprising the mobile phase organic modifier being of any of the solvents methanol (MeOH), other alcohols (EtOH, IPA etc), acetonitrile (MeCN), tetrahydrofuran (THF), or dimethylsulfoxide (DMSO), and the mobile phase ionic modifier being a weak hydrophobic base for anion-exchange chromatography, or acid for cation-exchange chromatography, each having long alkyl chain, the stationary phase ion-exchange functional group being a carboxylic acid or an amine base, and the column stationary phase hydrophobic interaction functional group being a long alkyl chain.
